(19) United States
(12) Patent Application Publication
(10) Pub. No.: US 2019/0054591 A1
(43) Pub. Date: Feb. 21, 2019

(54) ROLLER BURNISHING TOOL

(71) Applicant: Hoffmann GmbH Qualitätswerkzeuge, München (DE)

(72) Inventor: Karlheinz HAHN, Straubing (DE)

(21) Appl. No.: 16/167,829

(22) Filed: Oct. 23, 2018

Related U.S. Application Data
(63) Continuation of application No. PCT/EP2017/000523, filed on Apr. 25, 2017.

(30) Foreign Application Priority Data
Apr. 26, 2016 (DE) 10 2016 005 047.0

(51) Int. Cl. B24B 39/00; C21D 7/08; B24B 39/04

(52) U.S. Cl. CPC B24B 39/003; F16C 33/32; B24B 39/045; C21D 7/08

(57) ABSTRACT

The invention relates to a roller burnishing tool (10) having a roller support (12), which projects in an advancement direction (V) and on which, in a circumferential direction, at least one burnishing roller (14) for machining a workpiece surface is provided such that it can rotate about a roller axis (A), wherein the at least one burnishing roller (14) has a contact surface for coming into contact with the workpiece. According to the invention, the at least one burnishing roller (14) has a basic cylindrical shape and the at least one burnishing roller (14) is mounted such that it can be moved in a radial direction (R).

### CROSS-REFERENCE TO RELATED APPLICATIONS

This application is a continuation of PCT/EP2017/000523, filed Apr. 25, 2017, and claims priority to DE 10 2016 005 047.0, filed Apr. 26, 2016, both of which are incorporated by reference in their entirety,

### BACKGROUND OF INVENTION

### Field of Invention

The invention relates to a roller burnishing tool.

### Brief Description of Related Art

Such a roller burnishing tool is for example known from DE 10 2013 018 899 A1 and serves to smooth rough surfaces without cutting by conically-designed roller bodies in the form of burnishing rollers. The roller burnishing tool is used to smooth a metal surface that normally has a surface structure or a roughness after rough machining passes such as turning, milling, grinding, etc. In this case, the roller support of the roller burnishing tool that bears the burnishing rollers travels in a feed direction while rotating in a circumferential direction along a surface of the workpiece to be machined, wherein the burnishing rollers contact the surface to be machined. The surface layer of the workpiece is smoothed by plastic deformation due to pressure by the burnishing rollers. For this purpose, force directed perpendicular to the running surface (burnishing force) is applied to the burnishing rollers while burnishing. In addition to the smoothing effect, a strengthening effect on the workpiece is therefore also achieved.

The workpiece to be smoothed is for example made of a soft material such as aluminum, and the burnishing rollers are made of a harder material relative to the workpiece to be smoothed such as steel, hard metal or solid carbide. Hard metals are understood to be sintered carbide hard metals (cemented carbide). Hard metals consist mostly of 90-94% tungsten carbide, titanium carbide, tantalum carbide, chromium carbide or vanadium carbide (reinforcing phase) and 6-10% cobalt (matrix, binder, toughness component) as well as perhaps carbon. The tungsten carbide grains are an average of about 0.5-1 μm large. The cobalt fills in the gaps.

Whereas the smoothing effect is primary in conventional roller burnishing tools, the strengthening and deformation effect of the roller burnishing tool can also additionally be used.

It was accordingly revealed for example that grooves introduced into a surface to be machined with bars arranged therebetween are deformable with the assistance of a roller burnishing tool such that undercuts arise. The exerted rolling force presses from above on the bars while burnishing and flattens their peak sections, whereas the groove floor remains substantially unchanged. This effect can be particularly advantageous since the production of grooves with undercuts with the assistance of conventional cutting methods is complex and time-consuming. Then a coating material can be introduced into the grooves with the undercut, wherein this coating material can engage in the undercut sections of the grooves so that it is anchored very tightly in the grooves. Such a method is for example known from DE 10 2013 011 726.7.

However, it was revealed that, due to their conical design, the burnishing rollers according to DE 10 2013 018 899 A1 have different circumferential speeds along their longitudinal axis extending in their rotational axis, and therefore only roll sectionally on the surface to be machined as desired; however in other sections, they slide over the surface to be machined in an undesirable manner, which increases the wear of the roller burnishing tool and hence reduces its service life.

Document DE 198 45 226 A1 discloses a roller tool for flattening surface roughness on a hole surface. The roller tool comprises a drive shaft for introducing into a hole, and a roller device having a plurality of rollers arranged on an insertion end of the drive shaft. The roller device is arranged on a roller support device such that, when the shaft rotates, the rollers of the roller device roll at least partially on the roller support device, wherein the roller support device is formed from a sleeve which is elastically deformable under the pressure of the rollers. The roller device has a roller guide which is formed by an axially extending edge bar arranged coaxial to the longitudinal axis with roller seats formed like notches therein. Overall, the roller guide has a crown-like design integrally formed on the insertion end. The roller seats extend parallel to the longitudinal axis and have concavely formed guide surfaces that guide the rollers with sufficient play so that, in addition to a rotation of the rollers in the roller seats, a radial movement of the rollers is also possible. Between the roller guide and the bearing pin, the sleeve is located in a floating bearing arrangement on the bearing pin with an outer diameter that is dimensioned corresponding to the inner rolling radius r of the roller device such that the rollers can roll on the outer circumference of the sleeve.

Document DE 198 45 226 A1 does disclose a sleeve on the outer circumference of which the rollers roll; however, this sleeve only serves as a roller support device that can be deformed by the rollers so that when peaks of roughness are rolled over, an elevated pressure on the rollers results due to the elastic restoring force of the sleeve so that when the peaks of roughness are repeatedly rolled over, they are flattened. The sleeve is arranged floating on a bearing pin that is screwed into the shaft. Accordingly, the sleeve is not connected to the drive shaft so as to transfer drive force,

US 2002/0020062 A1 discloses a tool for machining inner surfaces. The tool has a shaft, a rotatable core, spherical elements and burnishing elements. In this case, the rotatable core is only in contact with the shaft via the spherical elements. Accordingly, the rotatable core is not connected to the shaft so as to transfer drive force.

DE 17 52 071 A1 discloses a mandrel for press-polishing holes. The mandrel has rollers which are designed cylindrically and run on a central cone arranged within the mandrel. The mandrel itself is the drive shaft and forms a cage for the rollers. The central cone is not connected to the mandrel so as to transfer drive force; rather, it is mounted in a floating manner between two balls.

It is therefore the object of the present invention to provide an improved roller burnishing tool.

### SUMMARY OF THE INVENTION

The object is solved according to the invention by a roller burnishing tool of the aforementioned type having the features characterized in claim 1. Advantageous embodiments of the invention are specified in the following claims.

With a roller burnishing tool of the aforementioned type, it is provided according to the invention that the inner roller is connected to a drive shaft of the roller burnishing tool so as to transfer drive force.

The advantage is that an arrangement similar to planetary gears is formed with a fixed outer hollow shaft. During operation, the inner roller, which is made to rotate by the driveshaft, transfers drive force to the at least one burnishing roller, which is then also made to rotate. The at least one burnishing roller then rolls on the surface to be machined which itself is fixed.

According to a preferred embodiment, the roller support has a rotational axis that runs substantially parallel to the roller axis. “Substantially” is understood to be lying within normal production tolerances. Accordingly, the roller burnishing tool can have a very simple design and is particularly easy to handle.

According to another preferred embodiment, the roller cage and the inner roller have a clearance fit. In this case, a “clearance fit” is understood to be a dimensioning of the roller cage and the inner roller in which a mechanical component can be moved freely relative to another component of the assembly or respectively functional unit after being installed. Accordingly, the smallest dimension of the inner diameter of the annular roller cage is always larger, in a borderline case also just as large, as the largest dimension of the outer diameter of the inner roller.

According to another preferred embodiment, the inner roller is releasably inserted into the roller cage. The inner roller can therefore be removed from the roller cage and be adapted to a new machining situation by being machined, or a first inner roller can be replaced with a second inner roller having a different outer diameter than the first inner roller in order to change, or respectively adapt the radial position of the burnishing roller, or respectively the limit of displaceability of the burnishing roller in a radial direction.

According to another preferred embodiment, the roller cage and the inner roller are made of a material pair having different materials. Accordingly, through a suitable material pair selection, the friction between the roller cage and the inner roller can be reduced. For example, the roller cage can be made of red brass, and the inner roller can be made of steel.

According to another preferred embodiment, at least one burnishing roller and the roller cage are made of a material pair having different materials. Accordingly, through a suitable material pair selection, the friction between the at least one burnishing roller and the roller cage can be reduced. For example, at least one burnishing roller is made of steel, hard metal or solid carbide.

According to another preferred embodiment, the inner roller has liquid-conveying ducts. Coolant and/or lubricant can be supplied through the liquid-conveying ducts to the assembly consisting of the inner roller and the roller cage in order to effectuate their cooling and/or lubrication.

According to another preferred embodiment, a plurality of inner rollers with different outer diameters for exchanging is provided. In this case, each of the plurality of the inner rollers has a different outer diameter. Accordingly, a first inner roller can be replaced with a second inner roller having a different outer diameter than the first inner roller in order to change, or respectively adapt the radial position of the burnishing roller, or respectively the limit of its displaceability in a radial direction.

According to another preferred embodiment, a roughening section with elevations that project radially to the outside with regard to the roller axis is provided. The projecting elevations can be formed by a diamond coating.

### BRIEF DESCRIPTION OF THE DRAWINGS

The invention will be further explained below with reference to the drawing. In the drawing,

FIG. 1 shows an exploded view of an exemplary embodiment of a roller burnishing tool.

### DETAILED DESCRIPTION OF THE INVENTION

The roller burnishing tool 10 according to the present exemplary embodiment has a roller support 12, a holder 28, a first spacer disc 30, a second spacer disc 32 and a cross nut 34.

The roller support 12 has a roller cage 22 that is annular and which rotatably bears a plurality of burnishing rollers 14. For this purpose, the roller cage 22 in the present exemplary embodiment is formed from two roller cage halves 36a, 36b with the same design which together form a number of burnishing roller seats 38 that correspond to the plurality of burnishing rollers 14. The burnishing roller seats 38 are designed in this case such that the inserted burnishing rollers 14 are mounted with play in a radial direction R.

The burnishing rollers 14 have a substantially cylindrical basic shape, wherein the lateral surface has a section with elevations 20 that for example are formed by a diamond coating.

Together with an inner roller 24, the roller support 12 forms an assembly 44, wherein the inner roller 24 also has an annular basic shape which is inserted in an interior of the roller cage 22 designed in the shape of a ring. A clearance fit exists between the roller support 12 and the inner roller 24. Accordingly, the inner diameter of the roller support 12 in the present exemplary embodiment is greater than the outer diameter of the inner roller 24. Consequently, the inserted inner roller 24 limits the displaceability of the burnishing rollers 14 inserted into the burnishing roller seats 38 in a radial direction R, i.e., in a radial inward direction, whereas the burnishing rollers 14 still have play in a radial outward direction.

The burnishing roller seats 38 in the present exemplary embodiment are arranged on the outer surface of the roller cage 22 spaced evenly from each other in the circumferential direction. Between two burnishing roller seats 38 in each case, two holes each are also formed in the present exemplary embodiment in which pins are inserted in a press fit in order to connect the two roller cage halves 36a, 36b to each other.

The roller cage 22 and the inner roller 24 are made of a material pair having different materials. In the present exemplary embodiment, the roller cage 22 is made of red brass, and the inner roller 24 is made of steel. Furthermore the roller cage 22 and the inserted burnishing rollers 14 are also made of a material pair having different materials. In the present exemplary embodiment, the burnishing rollers 14 are made of solid carbide.

Accordingly, through a suitable material pair selection, the friction between the roller cage 22 and the inner roller 24, as well as between the roller cage 22 and the burnishing rollers 24, can be reduced.

The inner roller 24 furthermore has liquid-conveying ducts 40 in the present exemplary embodiment in order to supply the roller support 12 with a lubricant and/or coolant such as a water/oil emulsion in the present exemplary embodiment to lubricate and cool.

In the present exemplary embodiment, the liquid-conveying ducts 40 each comprise a peripheral groove on the axial end faces of the inner roller 24 and duct sections extending in a radial direction.

The liquid-conveying ducts 40 are supplied with lubricant and/or coolant through an exit opening 42 which in the present exemplary embodiment is arranged on an end face of a drive shaft 26 of the holder 28.

In the present exemplary embodiment, the first spacer disc 30 is arranged at the proximal end of the roller burnishing tool 10, whereas the second spacer disc 32 and the cross nut 34 are arranged at the distal end of the roller burnishing tool 10.

The first spacer disc 30 has a greater thickness than the second spacer disc 32 so that the roller burnishing tool 10 can be easily lowered to the bottom of a cylinder formed as a blind hole in order to machine sections of the inner wall of the cylinder located there.

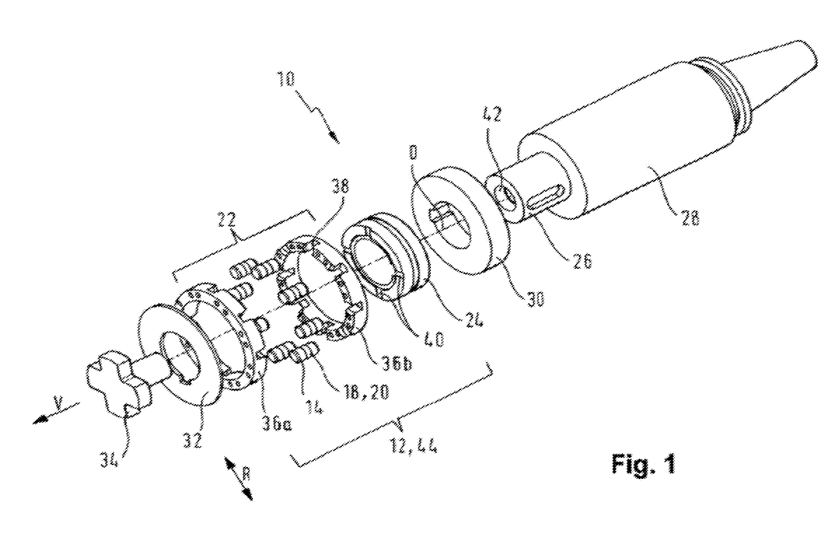

The cross nut 34 shown in FIG. 1 represents a nonrotating connection in the present exemplary embodiment between a drive shaft 26 of the holder 28 also shown in FIG. 1 and the inner roller 24.

During operation, the roller burnishing tool 10 is introduced in a feed direction V into a workpiece such as a cylinder of a cylinder block of a reciprocating engine, the inner surface of which is to be machined as a workpiece surface. That is, the inner cylinder surface is the surface to be machined.

The drive shaft 26 causes the inner roller 24 to rotate about the rotational axis D of the roller support 12. The rotation of the inner roller 24 in turn causes the burnishing rollers 14 to rotate about their respective roller axis A that are parallel to each other in the present exemplary embodiment.

Due to the rotation of the burnishing rollers 14 about their respective roller axis A, they roll on the cylinder inner surface to be machined. In other words, the roller burnishing tool 10 forms a planetary gear-like arrangement with the inner surface of the cylinder to be machined as a fixed outer hollow shaft.

The inner roller 24 prevents a displacement of the burnishing rollers 14 radially inward in a radial direction R so that contact between the burnishing rollers 14 and the inner surface to be machined is ensured.

Due to the play between the inner roller 24 and the roller cage 22, individual burnishing rollers 14 can be displaced in a radial direction R radially outward by displacing the inner roller 24 in the annular roller cage 22 in order to reestablish contact between the burnishing rollers 14 and the inner surface to be machined.

In order to decrease or increase the play that prevents the displacement of the burnishing rollers 14, the inner roller 24 can be removed from the roller can 24 and replaced with another second inner roller selected from a plurality of inner rollers with different outer diameters.

Alternatively, the inner roller 24 removed from the roller cage 24 can be machined to reduce its outer diameter and thereby increase the play that prevents the displacement of the burnishing rollers 14. This is advantageous when an inner diameter of the completely machined workpiece (inner diameter of a cylinder) is greater than a predetermined threshold.

Due to the cylindrical basic shape of the burnishing rollers 14 and their radial displaceability for ensuring contact between the burnishing rollers 14 and the inner surface to be machined, there are no sections with different circumferential speeds so that there is only one rolling movement of the burnishing roller 14 on the surface to be machined. The roller burnishing tool 10 is therefore subject to less wear, and the machining of the surface to be machined can be carried out with greater precision.

1. A roller burnishing tool comprising a roller support which projects in a feed direction and on which a plurality of substantially cylindrical burnishing rollers for machining a workpiece surface are circumferentially arranged, wherein each of said plurality of burnishing rollers is rotatable about a roller axis, wherein each of said plurality of burnishing rollers has an outer surface for contacting the workpiece surface, wherein each of said plurality of burnishing rollers is mounted so as to be displaceable in a radial direction, wherein the roller support comprises an annular roller cage that rotatably bears said plurality of burnishing rollers, wherein a substantially annular inner roller is disposed in the roller cage, wherein the inner roller has an outer surface, wherein the outer surface of the inner roller interacts with the outer surfaces of said plurality of burnishing rollers, and wherein the inner roller is connected to a drive shaft of the roller burnishing tool so as to transfer driving force.

2. The roller burnishing tool according to claim 1, wherein the roller support has a rotational axis that runs substantially parallel to the roller axis of each of said plurality of burnishing rollers.

3. The roller burnishing tool according to claim, wherein the inner roller is disposed within the roller cage with a clearance fit.

4. The roller burnishing tool according to claim 1, wherein the inner roller is releasably disposed within the roller cage.

5. The roller burnishing tool according to claim 1, wherein the roller cage is made of a different material than the inner roller.

6. The roller burnishing tool according to claim 1, wherein the roller cage is made of a different material than said plurality of burnishing rollers.

7. The roller burnishing tool according to claim 1, wherein the inner roller includes liquid-conveying ducts.

8. A roller burnishing tool set comprising:
a roller burnishing tool according to claim 1, and
a plurality of additional exchangeable inner rollers, said additional exchangeable inner rollers having different outer diameters.

9. The roller burnishing tool according to claim 1, wherein each of said burnishing rollers comprises a roughening section with elevations that project radially outward relative to the roller axis.
